(19) United States
(12) Patent Application Publication
(10) Pub. No.: US 2023/0247441 A1
(43) Pub. Date: Aug. 3, 2023

(54) METHOD OF DETERMINING LOCATION FOR INSTALLING MOVEABLE BASE STATION AND INFORMATION PROCESSING APPARATUS

(71) Applicant: NIPPON TELEGRAPH AND TELEPHONE CORPORATION, Tokyo (JP)

(72) Inventors: Toshiro NAKAHIRA, Tokyo (JP); Motoharu SASAKI, Tokyo (JP); Koichi ISHIHARA, Tokyo (JP); Takatsune MORIYAMA, Tokyo (JP); Yasushi TAKATORI, Tokyo (JP)

(21) Appl. No.: 18/004,950

(22) PCT Filed: Aug. 25, 2020
(86) PCT No.: PCT/JP2020/031959

§ 371 Date: Jan. 10, 2023

(51) Int. Cl. H04W 16/18

(52) U.S. Cl. CPC H04W 16/18

(57) ABSTRACT

A method of determining a location at which a movable base station is to be installed is provided. In the method, an information processing device performs first determination processing of determining a base station providing radio communication that does not satisfy a predetermined condition based on information of a radio signal of each base station, second determination processing of determining a number of virtual terminals to be set in a coverage area of the base station providing the radio communication that does not satisfy the predetermined condition based on the information of the radio signal of the base station, and third determination processing of determining the location at which the movable base station is to be installed based on a location of each virtual terminal set in the coverage area of the base station providing the radio communication that does not satisfy the predetermined condition.

### TECHNICAL FIELD

The present disclosure relates to a method of determining a location at which a movable base station is to be installed, and an information processing device.

### BACKGROUND ART

As wireless terminals including smartphones and tablets have rapidly spread in recent years, numbers of users of such wireless terminals who use large-volume contents have increased and the volume of traffic on wireless networks has been rapidly increasing. The IEEE 802.11 wireless LAN standard described in NPL 1, which is widely used as a high-speed wireless access system using radio waves in a band for which no license for a wireless system is required, is often used to easily accommodate radio traffic at a low cost. Wireless LAN networks are provided in various areas including private areas such as homes and offices and public areas such as stores, stations, and airports.

A wireless LAN network needs to be constructed with consideration given to various factors such as construction of radio base stations, factors relating to wireless LAN communication such as a parameter setting, factors relating to the network between a radio base station and a switch and between a switch and a backhaul line, and factors relating to higher layer services such as user authentication and portal screens.

If a radio signal attenuates due to a propagation distance or a shield in radio communication, the quality or the volume of the radio communication is usually lowered, and thus a state in which the distance between a radio base station and a radio terminal station is short and a line-of-sight propagation path can be ensured is desirable. In this regard, because the number of radio base stations to be installed is limited due to costs incurred for equipment, installation, and operations, radio wave interference, and the like, it is important to install a required number of radio base stations at appropriate places in an area covered by a wireless LAN. Furthermore, because there is a limit on traffic and the number of users that can be accommodated by one radio base station, a movable base station using radio connections on a backhaul line may be installed within an area.

As a method of calculating a location at which a movable base station is to be installed, for example, NPL 2 has proposed a technique of dynamically changing a location of a base station device in accordance with variation in a distribution of users in an area, and a clustering method called k-means method as disclosed in NPL 3 or the like is used to calculate the location at which the movable base station is to be installed according to locations of users within an area.

### CITATION LIST

### Non Patent Literature

[NPL 1] IEEE Std 802.11-2016, December 2016.

[NPL 2] Takuto Arai, Daisuke Goto, Masashi Iwabuchi, Tatsuhiko Iwakuni, and Kazuki Maruta “Adaptive Movable AP System for Offloading Efficiency Enhancement,” IEICE technical report, RCS2016-43, pp. 107-112, May 2016.

[NPL 3] J. Macqueen, “SOME METHODS FOR CLASSIFICATION AND ANALYSIS OF MULTIVARIATE OBSERVATIONS,” Proc. of 5th Berkeley Symposium on Mathematical Statistics and Probability, pp. 281-297, 1967.

### SUMMARY OF INVENTION

### Technical Problem

For example, a location at which a movable base station is to be installed may not be determined because location information of terminal stations in an area is not available.

An object of the present disclosure is to provide a technique capable of appropriately determining a location at which a movable base station is to be installed.

### Solution to Problem

According to the disclosed technique,

a method of determining a location at which a movable base station is to be installed is provided. In the method, an information processing device performs first determination processing of determining a base station providing radio communication that does not satisfy a predetermined condition based on information of a radio signal of the base station,

second determination processing of determining a number of virtual terminals to be set in a coverage area of the base station providing the radio communication does not satisfy the predetermined condition based on the information of the radio signal of the base station, and

third determination processing of determining the location at which the movable base station is to be installed based on a location of each of the virtual terminals set in the coverage area of the base station providing the radio communication that does not satisfy the predetermined condition.

### Advantageous Effects of Invention

According to the disclosed technique, a location at which a movable base station is to be installed can be appropriately determined.

### BRIEF DESCRIPTION OF DRAWINGS

FIG. 1 is a diagram illustrating an example of a functional configuration of an information processing device 10 according to an embodiment.

FIG. 2 is a flowchart for illustrating an example of processing of the information processing device 10 according to an embodiment.

FIG. 3 is a diagram for illustrating area information according to an embodiment.

FIG. 4 is a diagram for illustrating an example in which virtual terminals according to an embodiment are arranged in a virtual terminal arrangement area.

FIG. 5 is a diagram for illustrating processing of determining locations at which moving base stations are to be installed according to an embodiment.

FIG. 6 is a diagram for illustrating a determination result of locations at which moving base stations are to be installed according to an embodiment.

FIG. 7 is a diagram illustrating an example of a configuration of the information processing device 10 according to an embodiment.

### DESCRIPTION OF EMBODIMENTS

Hereinafter, embodiments of the present invention (present embodiments) are described with reference to the drawings. The embodiments described below are merely examples, and an embodiment to which the present invention is applied is not limited to the following embodiments.

### Functional Configuration

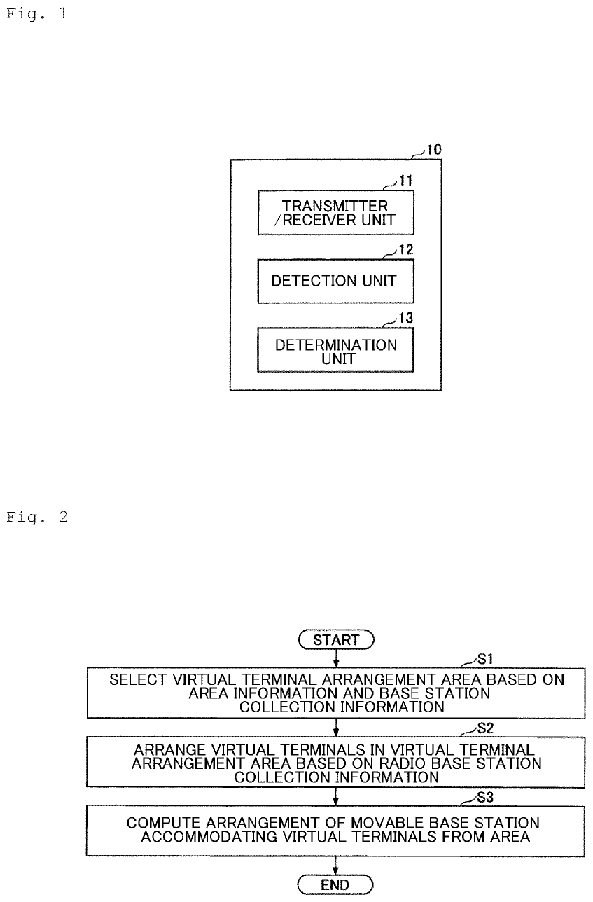

A functional configuration of the information processing device 10 according to an embodiment is described with reference to FIG. 1. FIG. 1 is a diagram illustrating an example of a functional configuration of the information processing device 10 according to the embodiment.

In the example illustrated in FIG. 1, the information processing device 10 according to the embodiment includes a transmitter/receiver unit 11, a detection unit 12, and a determination unit 13. These units may be implemented by cooperation of one or more programs installed in the information processing device 10 with hardware such as a CPU of the information processing device 10.

The transmitter/receiver unit 11 performs data transmission/reception with respect to external devices such as a base station via a core network, or the like, for example. The detection unit 12 detects predetermined information based on data acquired by the transmitter/receiver unit 11. The detection unit 12 detects (acquires), for example, area information, base station collection information, and the like, which are described below. The determination unit 13 determines a location at which a mobile base station (moving base station) is to be installed based on the information detected by the detection unit 12. Furthermore, the determination unit 13 may transmit information indicating the determined location at which the movable base station is to be installed to an external device to be displayed.

### Processing

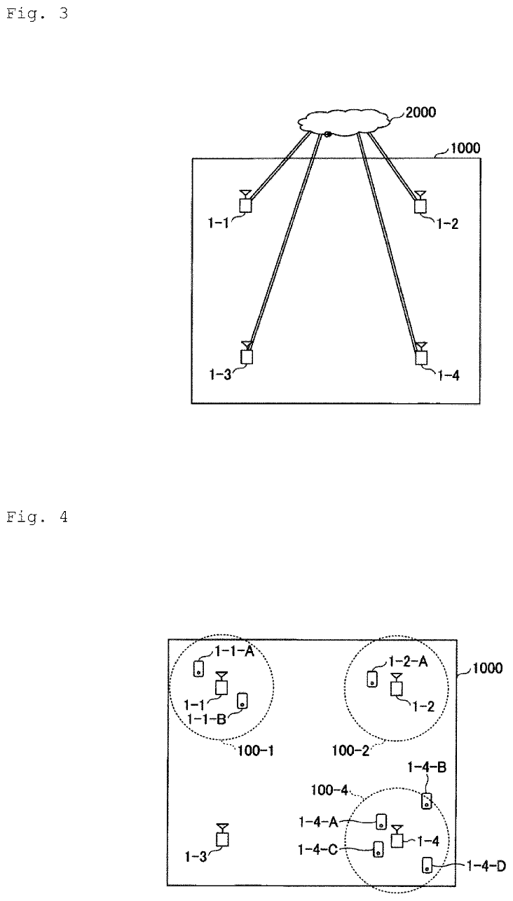

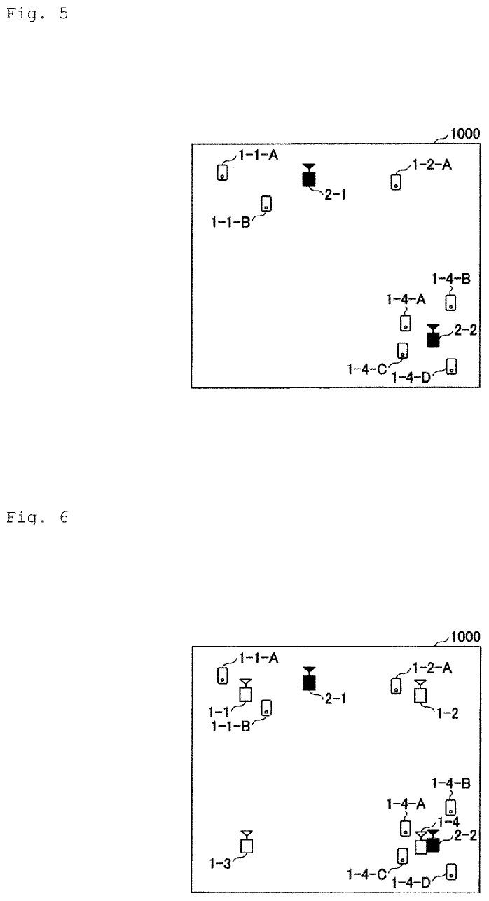

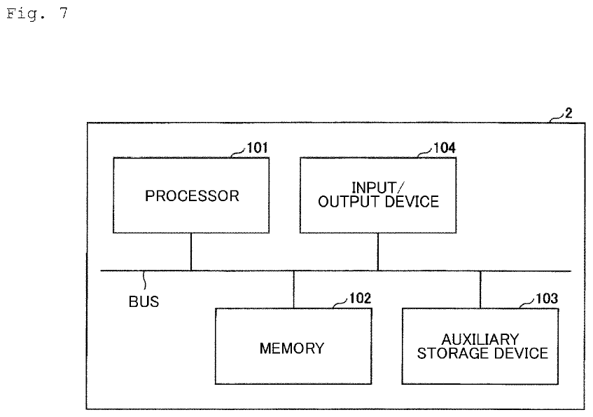

An example of processing of the information processing device 10 according to an embodiment is described with reference to FIG. 2 to FIG. 5. FIG. 2 is a flowchart for illustrating an example of processing of the information processing device 10 according to an embodiment. FIG. 3 is a diagram for illustrating area information according to an embodiment. FIG. 4 is a diagram for illustrating an example in which virtual terminals according to an embodiment are arranged in a virtual terminal arrangement area. FIG. 5 is a diagram for illustrating processing of determining locations at which moving base stations are to be installed according to an embodiment. FIG. 6 is a diagram for illustrating a determination result of locations at which moving base stations are to be installed according to an embodiment.

In step S1, the determination unit 13 of the information processing device 10 selects (determines) an area in which virtual terminals are to be arranged based on area information indicating an area (mesh) where each base station is to be installed and base station collection information that is radio environment information collected by each base station (the area is also be referred to as “virtual terminal arrangement area” as appropriate). Here, the virtual terminal is information for determining a location at which a movable base station is to be installed, and for example, when a terminal actually exists, the terminal is such that radio communication with a base station is assumed not to satisfy predetermined communication quality.

The area information may include information indicating an area 1000 in which each of base stations 1-1 to 1-4 connected to a network 2000 are installed as illustrated in FIG. 3. Furthermore, each of the base stations 1-1 to 1-4 may be a base station based on any of various standards such as 5G, 4G, and a wireless LAN. In addition, the area 1000 may be, for example, a region, such as a region of a mesh with a fixed size (for example, a 2-km square mesh) specified based on latitude and longitude. Furthermore, the area 1000 may be, for example, a region such as a circle having a predetermined radius (for example, a radius of 2 km) centered at a predetermined position.

The base station collection information may include identification information of the base station and information on a radio signal received from a terminal under control of (accommodated by) the base station. In this case, the information regarding the radio signal may include, for example, a channel of the radio signal, information indicating a received strength of the radio signal, information indicating a radio communication method, information of a channel use rate of a frequency channel on which the base station is operating, information of the terminal under control of the base station, and the like. The information indicating a received strength of the radio signal may include, for example, at least one of a received power indicating a power level by dBm that is the absolute value thereof in mW units and a received signal strength of the radio signal (Received Signal Strength Indicator or RSSI). Thus, for example, a location at which a movable base station is to be installed can be determined in consideration of attenuation of radio waves due to the distance between the base station and a user terminal, or the like.

Furthermore, the base station collection information may include information regarding a radio signal (radio wave) received from another base station installed in the vicinity. In this case, the information regarding the radio signal may include, for example, information indicating a channel of the radio signal and the received strength of the radio signal. Thus, for example, a location at which a movable base station is to be installed can be determined in consideration of radio wave interference caused by the distance to another radio base station.

In the processing of step S1, the determination unit 13 may first determine (presume) each base station providing radio communication that does not satisfy a predetermined condition based on the base station collection information. In this case, the determination unit 13 may determine, for example, a base station having a channel use rate (a channel use rate in a radio band or a channel utilization) equal to or greater than a threshold, a base station having a number of terminals under its control equal to or greater than a threshold, or a base station having a throughput estimated based on the information indicating the received strength of the radio signal equal to or less than a threshold, as a base station for which a virtual terminal is to be set.

In addition, the determination unit 13 may determine a coverage area (a service area or a cell) of each base station providing radio communication that does not satisfy a predetermined condition, as a virtual terminal arrangement area. In this case, the information processing device 10 may record (register) information indicating the coverage area of each base station in advance through an operation of the manager or the like. In addition, the determination unit 13 may calculate (estimate) a coverage area of each base station based on base station collection information acquired from the base station.

In step S2, the determination unit 13 of the information processing device 10 arranges (sets) a virtual terminal in the virtual terminal arrangement area based on the base station collection information.

In the example in FIG. 4, the determination unit 13 sets two virtual terminals 1-1-A and 1-1-B in a virtual terminal arrangement area 100-1 that is a coverage area of a base station 1-1, one virtual terminal 1-2-A in a virtual terminal arrangement area 100-2 that is a coverage area of a base station 1-2, and four virtual terminals 1-4-A to 1-4-D in a virtual terminal arrangement area 100-4 that is a coverage area of a base station 1-4.

The determination unit 13 may determine a random position in a virtual terminal arrangement area as an arrangement position of each virtual terminal. In this case, the determination unit 13 may determine an arrangement position in the virtual terminal arrangement areas based on, for example, a random number.

Furthermore, the determination unit 13 may determine a location of each of the virtual terminals such that the virtual terminals are uniformly arranged in the virtual terminal arrangement areas. In this case, the determination unit 13 may sequentially compute the location of each virtual terminal such that the sum of distances between the virtual terminals becomes large.

Furthermore, the determination unit 13 may set the number of virtual terminals to be arranged in a virtual terminal arrangement area to be equal for each of the virtual terminal arrangement areas. Furthermore, the determination unit 13 may determine the number of virtual terminals to be arranged in each virtual terminal arrangement area based on, for example, the base station collection information. In this case, for example, the determination unit 13 may determine that the number of virtual terminals to be arranged in the virtual terminal arrangement area of a corresponding base station becomes greater as the channel use rate of the base station becomes higher, as the number of terminals under control of the base station becomes greater, as a throughput estimated based on information indicating the received strength of a radio signal of the base station becomes lower. Thus, for example, movable base stations can be arranged in each area more appropriately.

In step S3, the determination unit 13 of the information processing device 10 computes (determines) a location at which the movable base station is to be installed in the area based on the locations of the virtual terminals arranged in respective virtual terminal arrangement areas. Thus, when an actual terminal is present at the location of a virtual terminal, it is expected that the terminal is accommodated by the movable base station.

Here, the determination unit 13 may determine the location at which the movable base station is to be installed, for example, based on the result of clustering the locations of the virtual terminals arranged in respective virtual terminal arrangement areas using the k-means method. In this case, the determination unit 13 may perform clustering in, for example, the following processing.

(1) The determination unit 13 selects, as representative points, a predetermined number k of virtual terminals from among the virtual terminals. (2) Then, the determination unit 13 calculates the distance between each virtual terminal selected as a representative point and another virtual terminal, and classifies (groups) the other virtual terminals into the same cluster as that of the representative point with the closest distance from the other virtual terminals. (3) Then, the determination unit 13 computes the average or the like of the locations of the respective virtual terminals classified into each cluster as the center of gravity. (4) Then, if there is a difference between the center of gravity and the representative point, the processing returns to the processing (2) by setting the center of gravity as a new representative point. In this regard, if there is no difference between the center of gravity and the location of the representative point in each cluster, the clustering is terminated.

In addition, the determination unit 13 may determine, for example, a location corresponding to the center of gravity of each cluster as a location at which a movable base station is to be installed.

Note that, the movable base station may be, for example, a base station mounted on a vehicle (a mobile base station vehicle), a portable base station for communication with a core network via a satellite or the like.

In the example in FIG. 5, locations at which movable base stations 2-1 and 2-2 are to be installed are determined based on locations of virtual terminals arranged in each virtual terminal arrangement area described with reference to FIG. 4. As a result, the locations of the base stations 1-1 to 1-4, the locations of the terminals, and the locations of the movable base stations 2-1 and 2-2 are as those of illustrated in FIG. 6.

In this regard, for example, it is considered that a movable base station corresponding to the latest standard may be additionally installed in an area where base stations based on a legacy standard have been installed. In this case, if a base station installed close to a movable base station has a function of steering (instructing a connection destination) a terminal under its control, communication can be efficiently performed by steering the terminal under its control toward the movable base station to connect to the movable base station according to the radio standard of the terminal.

### Advantageous Effects of Present Disclosure

A technique of dynamically changing a location of a base station device in accordance with variation in a distribution of users in an area has been proposed, and a method of computing a location at which a movable base station is to be installed according to locations of users within an area by using a clustering method called k-means method, or the like has been proposed in the related art. These methods are based on the assumption that locations of users and variations in a distribution of the users are known. However, in an actual system, it is usual that such information cannot be calculated.

According to the above-described technique of the present disclosure, a location at which a movable base station is to be installed can be appropriately determined.

### Other Configuration Examples

The function of each functional block of the information processing device 10 illustrated in FIG. 1 may be implemented by dedicated hardware (an LSI or the like), or by a general-purpose computer having a processor (a CPU, a DSP, or the like) and a memory, and software operating on the computer.

FIG. 7 illustrates an example of a configuration of the information processing device 10 when the information processing device 10 is implemented by using a computer and software.

The information processing device 10 includes a processor 101, a memory 102, an auxiliary storage device 103, and an input/output device 104, and they are connected by a bus, as illustrated in FIG. 7.

For example, a program for implementing the processing of the information processing device 10 is stored in the auxiliary storage device 103 (a computer-readable recording medium). When the information processing device 10 operates, the program is read into the memory 102, and the processor 101 reads the program from the memory 102 and executes the program. For example, the processor 101 executes the processing of the determination unit 13 or the like according to the program.

In addition, the “computer-readable recording medium” may include, for example, a portable medium, such as a flexible disk, a magneto-optical disk, a ROM, or a CD-ROM, a hard disk built into a computer system, or the like. In addition, the “computer-readable recording medium” may also include a recording medium that dynamically retains a program for a short period of time, such as a network, e.g., the Internet, or a communication line in a case where a program is transmitted through the communication line, e.g., a telephone line, and a recording medium that retains a program for a certain period of time, such as a volatile memory inside the computer system that serves as a server or a client in that case.

Although the embodiments are described above, the present invention is not limited to such a specific embodiments, and various modifications and changes can be made within the scope of the gist of the present invention set forth in the claims.

### REFERENCE SIGNS LIST

10 Information processing device

11 Transmitter/receiver unit

12 Detection unit

13 Determination unit

1-1 to 1-4 Base station

1-1-A, 1-1-B, 1-2-A, 1-4-A to 1-4-D Virtual terminal

2-1, 2-2 Movable base station

100-1, 100-2, 100-4 Virtual terminal arrangement area

101 Processor

102 Memory

103 Auxiliary storage device

104 Input/output device

1000 Area

2000 Network

1. A method of determining a location at which a movable base station is to be installed, the method executed by an information processing device, the method comprising:
determining a base station providing radio communication that does not satisfy a predetermined condition, based on information of a radio signal of the base station;
determining a number of virtual terminals to be set in a coverage area of the base station providing the radio communication that does not satisfy the predetermined condition based on the information of the radio signal of the base station; and
determining the location at which the movable base station is to be installed based on a location of each of the virtual terminals set in the coverage area of the base station providing the radio communication that does not satisfy the predetermined condition.

2. The determination method according to claim 1, wherein, in the determining the base station, the base station providing the radio communication that does not satisfy the predetermined condition is determined based on at least one of a channel use rate of the base station, the number of terminals under control of the base station, or information indicating a received strength of a radio signal from the base station.

3. The method according to claim 1, wherein, in the determining the number of virtual terminals, the number of the virtual terminals set in the coverage area of the base station providing the radio communication that does not satisfy the predetermined condition is determined based on at least one of the channel use rate of the base station, the number of terminals under control of the base station, and the information indicating a received strength of the radio signal from the base station.

4. The method according to claim 1, wherein in the determining the location at which the movable base station is to be installed, the location at which the movable base station is to be installed is determined based on a result of clustering of the locations of the virtual terminals set in the coverage area of the base station providing the radio communication that does not satisfy the predetermined condition by using a k-means method.

5. An information processing device comprising:
a processor; and
a memory that includes instructions, which when executed, cause the processor to execute the following steps:
determining a base station providing radio communication that does not satisfy a predetermined condition, based on information of a radio signal of the base station,
determining a number of virtual terminals set in a coverage area of the base station providing the radio communication that does not satisfy the predetermined condition based on the information of the radio signal of the base station, and
determining a location at which a movable base station is to be installed based on a location of each of the virtual terminals set in the coverage area of the base station providing the radio communication that does not satisfy the predetermined condition.
